(19) United States
(12) Patent Application Publication
(10) Pub. No.: US 2026/0076153 A1
(43) Pub. Date: Mar. 12, 2026

(54) HETEROGENEOUS SYSTEM-ON-A-CHIP (SoC) BASED SYSTEM WITH MULTIDIMENSIONAL DIFFERENTIATION

(71) Applicant: Rockwell Collins, Inc., Cedar Rapids, IA (US)

(72) Inventors: Matthew P. Corbett, Mount Vernon, IA (US); Eric N. Anderson, Marion, IA (US); Jason R. Owen, Marion, IA (US); Russ D. Uthe, Ely, IA (US)

(21) Appl. No.: 19/345,672

(22) Filed: Sep. 30, 2025

Related U.S. Application Data
(63) Continuation-in-part of application No. 18/639,523, filed on Apr. 18, 2024, now Pat. No. 12,461,835.

(51) Int. Cl. H01L 21/66; G06F 30/32; G06F 30/39; G06F 115/02

(52) U.S. Cl. CPC H10P 74/277; G06F 30/32; G06F 30/39; G06F 2115/02

(57) ABSTRACT

A method for fabrication of a heterogenous system on a chip (SoC) or other like integrated circuit (IC) device provides at least two dissimilar processing cores sharing a common functional profile but differentiated as to how the common functional profile is implemented. For example, the common functional profile may define the physical and logical configuration of each core, the functions and/or languages executable thereon, and any external interconnects to other devices or systems. However, each core may have a distinct implementation profile differentiated from that of the other on one or more levels of decomposition, based on differences in the underlying configuration of logical devices, the circuit components of said logical devices, and/or the physical design parameters including process geometries, fabrication standards, and/or fabrication processes via which the functional profile is physically realized in each core.

### CROSS-REFERENCE TO RELATED APPLICATIONS

This application claims priority under 35 U.S.C. § 120 as a continuation-in-part of U.S. patent application Ser. No. 18/639,523 entitled SYSTEM AND METHOD FOR INTEGRITY MONITORING OF HETEROGENEOUS SYSTEM-ON-A-CHIP (SoC) BASED SYSTEMS, filed Apr. 18, 2024 and allowed Jun. 18, 2025. Said U.S. patent application Ser. No. 18/639,523 is herein incorporated by reference in its entirety.

### BACKGROUND

Integrated modular avionics (IMA) systems require high data integrity (e.g., 1E⁻⁹ or better) solutions in order to ensure the avionics system never presents hazardously misleading information (HMI). For example, communications systems may encrypt or decrypt outbound or inbound messages, or encapsulate commands (e.g., via CRC checksum) to ensure payload integrity. Navigations and operations systems may receive a constant flow of raw data (e.g., sensor readings, environmental conditions, air data, timing information); this raw data may be used for other calculations (e.g., aircraft configuration, heading) and/or presented to the pilot or crew in a variety of formats. Some or all of this information, as well as the onboard applications and functions making use of the data, may be safety critical in that erroneous results of data processing or loss of function may endanger the aircraft, its crew, and its passengers.

Even assuming the validity of raw input data, undetected design flaws in processing hardware may create common mode faults which may in turn result in erroneous results or loss of function. Undetected errors may include transient errors, design errors, or production errors. Adherence to best design practices may reduce the probability of undetected errors but not eliminate them entirely. Development of specific logic for monitoring safety critical functions and outputs for common mode faults increase the size, weight, power, and cost (SWAP-C) factors associated with the resulting IMA system. Dual lockstep computing and triple modular redundancy (TMR) are established approaches for mitigating common mode faults due to design flaws. Similarly, higher level A/B or left-right differences in hardware and software solutions may be deployed. However, none of these approaches are ideal or optimal, either from a SWAP-C perspective or in terms of their effectiveness (e.g., due to the multiple processing targets for which application providers must develop and/or integrate).

### SUMMARY

In a first aspect, a method of fabricating a heterogeneous integrated circuit (IC) device is disclosed. In embodiments, the method may include fabricating at least a first and a second processing core according to a common functional profile but according to different implementation profiles. For example, the first type implementation profile may be defined by logical devices of a first type, each first type logical device based on a first type of circuit design profile. Additionally or alternatively, the first type implementation profile may be defined by a first set of physical parameters. Similarly, the second processing core may be fabricated according to a second type implementation profile dissimilar to the first type implementation profile. For example, the second type implementation profile may include one or more second types of logical devices based on second type circuit design profiles, different from the first type circuit design profiles, and/or second-type physical parameters dissimilar to the first-type parameters.

In some embodiments, the method may include fabricating the IC device as a system on a chip (SoC).

In some embodiments, the method may include fabricating the first type of logical devices based on logic gates and/or data storage elements (e.g., registers) according to the first type circuit design profile, and the second type of logical devices based on logic gates and/or data storage elements according to the second type circuit design profile.

In some embodiments, the first type circuit design profile may include first type netlists, and the second type circuit design profile may include second type netlists dissimilar to the first type netlists.

In some embodiments, the first type and second type physical design parameters may include process geometries and fabrication standards dissimilar to each other.

In some embodiments, the first type and second type fabrication standards may include dissimilar fabricators, vendors, and/or suppliers.

In some embodiments, the first type and second type fabrication standards may include dissimilar masking and/or doping processes.

In some embodiments, the common functional profile shared by the first type and second type processing cores may be defined by functions executable on either type of core, physical processors common to either type of core, and/or external interconnects for connecting the first type or second type cores to other processing cores and/or other IC devices.

In a further aspect, a heterogeneous IC device is disclosed. In embodiments, the IC device may include at least a first type of processing core and a second type of processing core, both types of processing core fabricated according to a common functional profile but according to dissimilar first type and second type implementation profiles. For example, each type of implementation profile may be defined by dissimilar types of logical devices or circuits, each logical device comprising a set of circuit elements, and/or dissimilar sets of physical design parameters.

In some embodiments, the IC device may be a system on a chip (SoC).

In some embodiments, the first type of logical devices may be fabricated based on logic gates and/or data storage elements (e.g., registers) according to the first type circuit design profile, and the second type of logical devices based on logic gates and/or data storage elements according to the second type circuit design profile.

In some embodiments, the first type circuit design profile may include first type netlists, and the second type circuit design profile may include second type netlists dissimilar to the first type netlists.

In some embodiments, the first type and second type physical design parameters may include process geometries and fabrication standards dissimilar to each other.

In some embodiments, the first type and second type fabrication standards may include dissimilar fabricators, vendors, and/or suppliers.

In some embodiments, the first type and second type fabrication standards may include dissimilar masking and/or doping processes.

In some embodiments, the common functional profile shared by the first type and second type processing cores may be defined by functions executable on either type of core, physical processors common to either type of core, and/or external interconnects for connecting the first type or second type cores to other processing cores and/or other IC devices.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims. In the drawings:

FIG. 1 is a block diagram illustrating a heterogeneous integrated circuit (IC) device or like multi-core processing environment according to example embodiments of the inventive concepts disclosed herein; and

FIG. 2A is a block diagram illustrating common functional profiles and differentiated implementation profiles within the IC device of FIG. 1;

FIG. 2B is a block diagram illustrating components of the common functional profile of the IC device of FIG. 1;

and FIG. 2C is a block diagram illustrating components of the dissimilar implementation profiles of the IC device of FIG. 1; and

FIG. 3 is a process flow diagram illustrating a method of fabricating a heterogeneous IC device according to example embodiments of the inventive concepts disclosed herein.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

The following U.S. Patents and Patent Applications are herein incorporated by reference in their entirety: U.S. Pat. No. 10,719,356 titled “High integrity multicore computing environment with granular redundant multi-threading”; U.S. Pat. No. 11,224,094 titled “Shared networking infrastructure with multi-link channel bonding”; U.S. Pat. No. 10,114,777 titled “I/O synchronization for high integrity multicore processing”; U.S. Pat. No. 10,242,179 titled “System-on-chips”; U.S. Pat. No. 11,494,256 titled “Memory scanning operation in response to common mode fault signal”; U.S. Pat. No. 11,591,092 titled “Dissimilar microcontrollers for outflow valve”; U.S. Pat. No. 9,454,418 titled “Method for testing capability of dissimilar processors to achieve identical computations”; patent application Ser. No. 18/639,523 titled “System and method for integrity monitoring of heterogeneous system-on-a-chip (SoC) based systems”; and patent application Ser. No. 18/639,573 titled “Temporal buffering of integrity comparison data”.

Broadly speaking, embodiments of the inventive concepts disclosed herein are directed to a heterogeneous multi-core processing system incorporating additional dimensions of differentiation to further reduce the probability of hazardously misleading information (HMI) or loss of function due to common mode design faults within the system. For example, each SoC may incorporate application cores on which safety-critical avionics applications and/or processes may be configured for execution, as well as integrity cores for monitoring the outputs of the safety-critical applications.

In embodiments, each SoC may be functionally identical in that any SoC generated according to the inventive concepts disclosed herein may be interchangeable with any other such SoC. For example, the functional definition of a given SoC may include the set of its components, e.g., processing cores, graphics processors, and/or memory and data storage, as well as how these components will be connected both internally and externally. However, in embodiments functionally identical SoCs, or SoCs sharing a common functional definition, may be differentiated from each other on the basis of their component hardware. For example, within a given SoC having a given functional definition and incorporating two or more different processing core types (e.g., application and integrity monitoring cores) as described above, each of the first and second core types (at least) may comprise a specific set of integrated circuit elements, e.g., digital or analog integrated circuits configured for specific functions or applications such as the processing of digital data and/or analog signals. Deeper still, each integrated circuit element may comprise a set of electronic circuit components arranged and interconnected in a specific configuration. These individual circuit elements, and their underlying components and interconnects, may be physically designed and/or fabricated in a variety of different ways while serving the same functional definition. While each of the millions upon millions of circuit elements, or billions of transistors, may provide opportunities for undetected defects, the incorporation of different physical designs and/or fabrications similarly provides greater opportunities to mitigate these defects compared to, e.g., an instruction set architecture (ISA) comprising mere hundreds of functions.

Similarly, in embodiments two functionally identical SoCs sharing a common functional definition may differ in terms of their software toolchain. For example, where SoC cores may employ relatively well-known program code languages and/or ISAs (e.g., given common higher-level functions in alignment with their common functional definition), differentiation of multiple SoCs within the system according to independent lower-level (e.g., compilers, linkers) may further mitigate the risk of undetected common defects within the multi-core processing environment.

In embodiments, “processing cores” and “processing core types” may refer to physical processing components of a larger SoC. For example, “processing cores” may refer to physical processors connected to a chip or circuit board. “Processing cores” may alternatively refer to physical or virtual partitions of a physical processor, such that a single physical processor may be partitioned into multiple processing cores, each core sharing the fabrication profile of the underlying physical processor.

In embodiments, processing core/s of a first type may be deliberately dissimilar to the processing core/s of a second type in order to reduce or mitigate the risk of common mode faults or otherwise undetectable errors associated with one processing core type but not necessarily with another. For example, as disclosed in incorporated related patent application Ser. No. 18/639,523, monitoring cores and application cores of dissimilar core type may incorporate dissimilar instruction set architectures (ISA).

In embodiments, “hosted application” refers to any application or process configured for execution on an application processing core. For example, hosted applications may receive sets of input data and, based on a particular set or sets of input data, produce a particular output by performing a set or sequence of calculations and/or functions. As noted above, common mode faults or otherwise undetectable errors (e.g., associated with the physical properties of the underlying application core) may cause this output to be erroneous or otherwise deviant from the expected output given a particular input; in some cases, e.g., with respect to safety-critical applications or functions such as positioning or display systems, output may be sufficiently erroneous or deviant as to constitute hazardously misleading information (HMI) or lead to loss of function in one or more of said applications or functions which may endanger the aircraft and any personnel and/or cargo aboard.

In embodiments, “integrity application” may refer to an application configured for execution on an application processing core and for mirroring functions otherwise configured for execution via one or more hosted applications on that application processing core. For example, an integrity application running on a particular application core may mirror specific safety-critical functions associated with a hosted application also running on that application core, and may receive the same input data concurrently with the hosted application. Similarly to the hosted application, the integrity application may generate one or more integrity outputs. In embodiments, the integrity outputs may be forwarded to a monitoring processing core for review by an integrity monitor. Under ideal conditions, the integrity output generated by the integrity application and the application output generated by the hosted application (based on the same input data) should be both equivalent and correct. In practice, however, undetectable errors associated with the application core may affect the hosted application and integrity application similarly, such that the application output and integrity output may be equivalent, but both may be inaccurate or deviant.

In embodiments, “integrity monitor” may refer to an application configured for execution on a monitoring processing core.

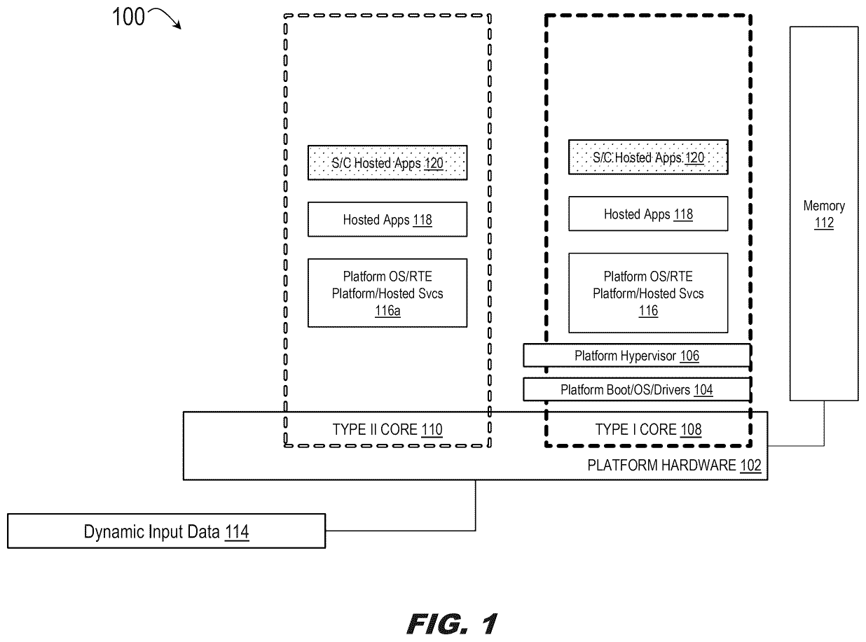

### FIG. 1—System Differentiation Via Fabrication Profile

Referring now to FIG. 1, a heterogeneous multi-core processing environment embodied in a system-on-a-chip (SoC) or like integrated circuit (IC) device 100 (SoC) is shown. The IC device 100 may include platform hardware 102, platform software 104 (e.g., boot, operating system (OS), drivers), platform hypervisor (e.g., virtual machine (VM)) 106, type I processing core/s 108, type II processing core/s 110, memory 112, and dynamic input data 114 (live input data).

In some embodiments type I processing cores 108 a single physical processing core may be partitioned into two or more virtual application processing cores.

In embodiments, the IC device 100 may be heterogeneous (e.g., heterogenous) in that the type I processing cores 108 and the type II processing core/s 110 may be fundamentally dissimilar in one or more aspects. For example, the IC device 100 may be implemented and may function similarly to that disclosed by related and incorporated patent application Ser. No. 18/639,523, except that embodiments of the IC device 100 disclosed herein may differentiate the type I processing cores 108 and type II processing cores 110 (and/or additional processing core types, as applicable) according to additional dimensions as disclosed below.

In embodiments, the type I processing cores 108 SoC 100 may include a dual lockstep pair of type I processing cores 108 and/or a dual lockstep pair of type II processing cores 110, respectively. For example, the dual lockstep pair of processing cores 108 may be synchronized and/or the dual lockstep pair of the type II processing cores 110 may be synchronized for detecting transient faults with the application processing cores and/or the monitoring processing cores, respectively. By way of another example, the type I processing cores 108 and/or the type II processing cores 110 may include N-modular redundancy with N of the type I processing cores and/or N of the type II processing cores, respectively, where N is an integer. For example, N may be the integer three, such that triple-modular redundancy is provided.

In embodiments, the type I processing cores 108 and/or the type II processing cores 110 may experience one or more faults. For example, the type I processing cores 108 and/or the type II processing cores 110 may experience transient faults and/or common mode faults. Transient faults may include single event upsets, e.g., when ionizing particles strike the type I processing cores 108 and/or the type II processing cores 110. Common mode faults may occur where identical type I processing cores 108 or type II processing cores 110 fail in the same way and/or for the same reason. Common mode faults may or may not be detected during design and testing of either type of processing core. In embodiments, the type I processing cores 108 and/or the type II processing cores 110 may not experience the same common mode faults due to the heterogeneity and/or dissimilarity of the type I and type II processing cores, e.g., the dissimilarity of application cores and monitoring cores. For example, a type I processing core 108 may not experience a common mode fault to which a type II processing core 110 is subject, and vice versa.

In embodiments, the type I processing cores 108 and/or the type II processing cores 110 may include triple-modular redundancy with three of the type I processing cores and/or triple modular redundancy with three of the type II processing cores, respectively. For example, the N-modular redundancy may enable detecting the transient faults; however, detection of transient faults may not enable detection of common mode faults of the type I processing cores 108 and/or the type II processing cores 110. Processing cores of similar type may each experience the same common mode faults. Thus, dual lockstep pairing and/or N-modular redundancy may not enable detection of common mode faults.

In embodiments, the type I processing cores 108 and the type II processing cores 110 may include any type of processing cores, so long as the type I and type II processing cores (as well as any additional core types, as applicable) are dissimilar as disclosed below. For example, the type I processing cores 108 may include any number of homogeneous processing cores and the type II processing cores 110 may include any number of homogenous cores, so long as the type I and type II processing cores are heterogeneous relative to each other.

In embodiments, the underlying platform hardware 102 may include the type I processing cores 108 and type II processing cores 110 as well as any associated graphics processors and hardware, network input/output (I/O) hardware, and/or custom hardware. For example, the type II processing core 110 may include (e.g., be partially or fully embodied in) a specialized processing unit, e.g., a graphics processing, digital signal processor (DSP), or any other appropriate processor partition or processing core dissimilar to and distinct from the type I processing cores 108 as described below.

In embodiments, the type I processing cores 108 may include platform software 116 (e.g., operating system (OS) and/or run-time environment (RTE) as well as platform services and hosted services). Similarly, the type II processing core 110 may also include platform software 116a (e.g., compatible with the dissimilar type I processing core). Further, each of the type I processing cores 108 may include a set of hosted applications 118 configured for execution on that core. For example, hosted applications 118 may be associated with the operation of one or more aircraft systems or subsystems.

In embodiments, one or more type I processing cores 108 may include safety critical (S/C) hosted applications 120 configured for execution thereon. For example, S/C hosted applications 120 may include any application receiving dynamic input data 114 (e.g., traffic control systems, avionics systems, navigation systems, life support systems, engine control systems) wherein failure, malfunction, and/or erroneous output (e.g., hazardously misleading information) may result in 1) damage to the aircraft, other equipment or property, and/or the environment generally; or 2) harm to the pilot, crew, passengers, or nearby personnel. In embodiments, dynamic input data 114 may include one or more of: air data (e.g., air pressure and/or temperature external to an aircraft); timing data; position data (e.g., absolute (e.g., latitude, longitude) or relative position (e.g., inertial reference, position relative to terrain and/or landmarks) of an aircraft; attitude (e.g., roll, pitch, yaw, angle of attack); engine data (e.g., fuel consumption, RPM); flight control information (e.g., control surface positions and/or states); cabin pressure. Further, dynamic input data 114 may be dynamic in that such data is continually generated by various systems and is provided to the IC device 100 on a near constant basis. Even when dynamic input data 114 is itself accurate, undetected design flaws in the type I processing cores 108 may cause S/C hosted applications 120 to output erroneous, and potentially hazardous, data or may cause systems and/or devices served by S/C hosted applications to lose functionality.

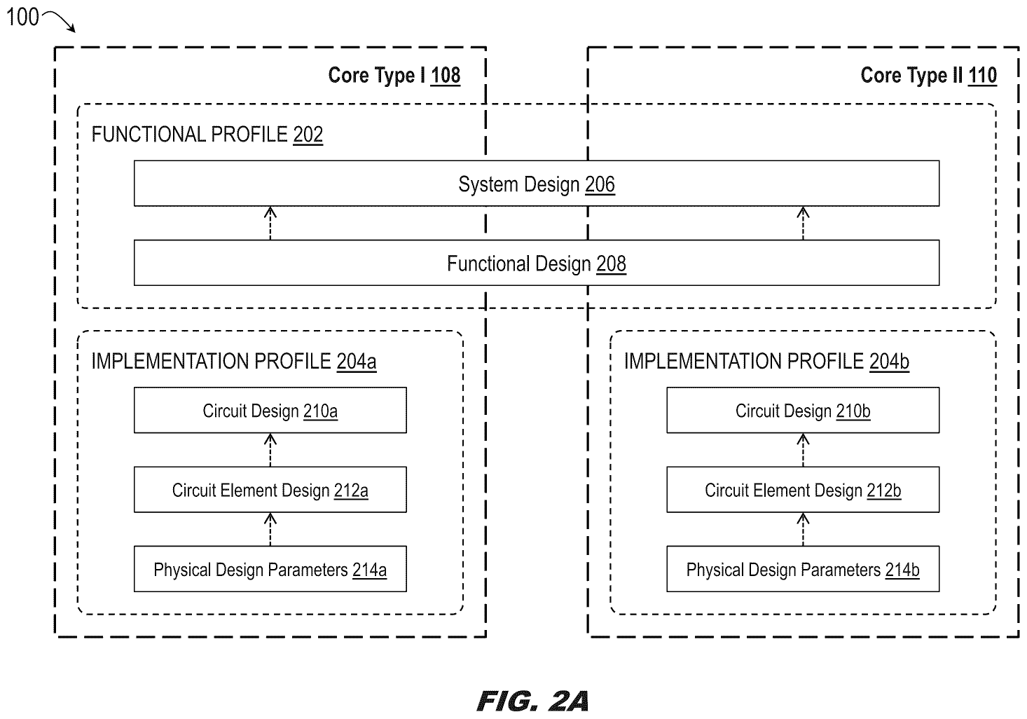

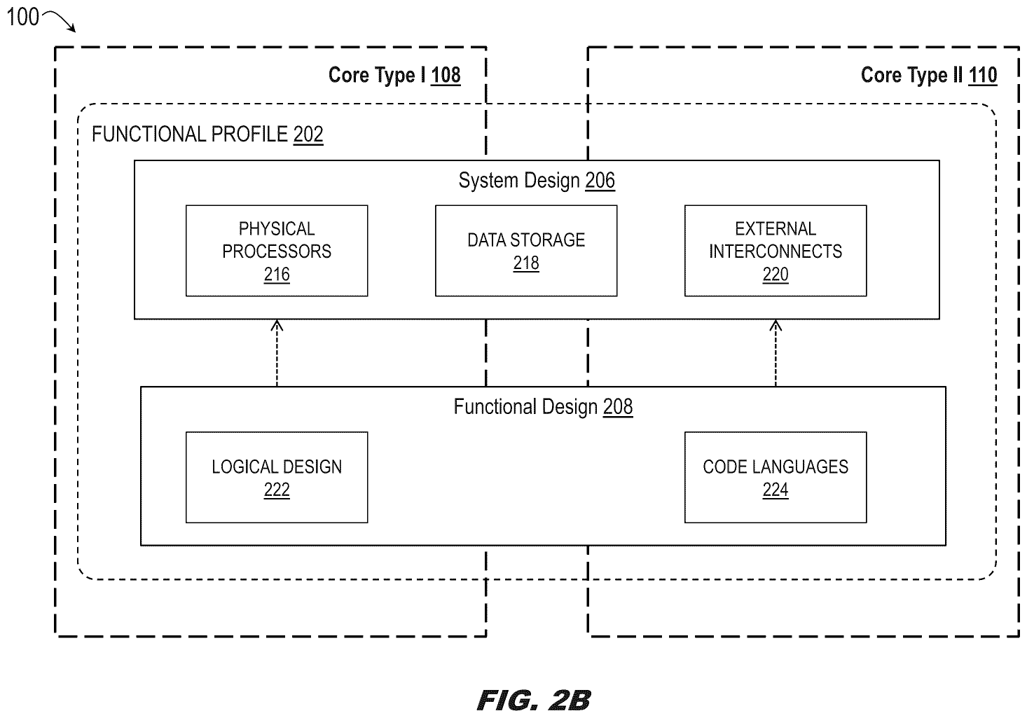

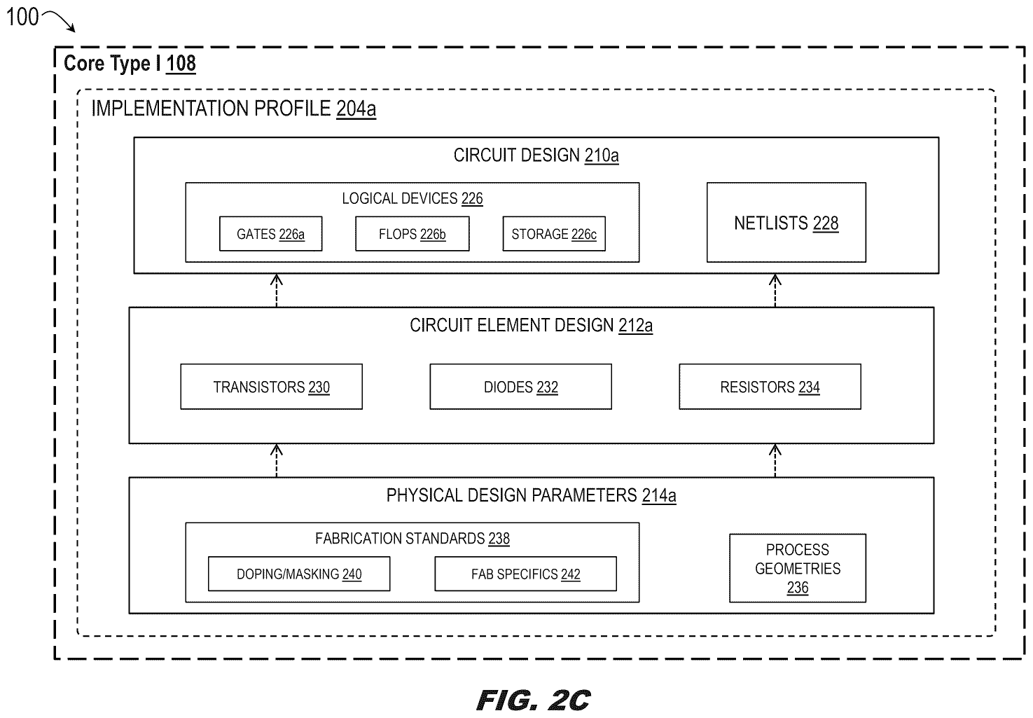

### FIGS. 2A-2C—Functional vs. Implementation Profile

Referring also to FIG. 2A, as noted above the IC device 100 shown by FIG. 1 may incorporate type I and type II processor cores 108, 110 that are additionally or alternatively dissimilar from, e.g., the application and monitoring processing cores described in incorporated related application Ser. No. 18/639,523, in that the type I and type II processing cores may be fabricated according to a common (i.e., shared) functional profile 202 (e.g., device definition) but according to dissimilar different implementation profiles 204a, 204b. For example, this dissimilarity or differentiation via implementation profiles 204a, 204b may mitigate common mode errors and/or other like undetectable design errors within the IC device 100 as described above. In embodiments, the processor core types 108, 110 may be implemented and may function similarly to the respective type I processing cores 108 and type II processing cores 110 described above and in the related application Ser. No. 18/639,523, except that within the IC device 100 the dissimilar processor core types 108, 110 may be differentiated as described below.

In embodiments, the common functional profile 202 shared by type I and II processing cores 108, cores 110 within the IC device 100 may incorporate both a system design profile 206 and a functional design profile 208 (e.g., logical design). For example, the IC device 100 as a whole may incorporate type I and II cores 108, 110, platform hardware and software 102, 104, 106, 116-116a as also shown by FIG. 1, as well as multiple peripheral devices, coprocessors (e.g., graphics processors), and memory 112 or data storage, and interfaces and/or interconnects (not shown) via which the IC device 100 connects to the underlying chip and/or peripherals. Further, each functional component of the IC device 100, e.g., processor cores 108, 110, external interfaces, internal interfaces (such as between cores) may be defined as a logical block. Accordingly, the system design profile 206 may define the overall connection of functions and interfaces corresponding to the IC device 100 as a whole, while the functional design profile 208 may incorporate the specific logical design of each component function or interface.

In embodiments, the dissimilar processor core types 108, 110 may be functionally identical integrated circuit (IC) devices, and redundant devices, in that both core types share the same set of physical and logical interfaces. For example, and referring also to FIG. 2B, the common functional profile 202 may include a common system design profile 206 providing for the set of physical processors 216 (e.g., ARM, Intel), graphics processors, and memory or data storage units 218 defining the IC device embodied in either core type 108, 110, and/or external interconnects 220 via which each processing core is connected to an underlying SoC or to other IC devices.

In embodiments, the common functional profile 202 may further include an element or functional design profile 208 (e.g., functional specification, instruction set architecture (ISA)) defining the set of functions executable via either core type 108, 110, and/or the specific logical design 222 of each individual circuit, component or interface addressed by the system design profile 206. Further, the functional design profile 208 may specify code languages 224 (e.g., C, Ada) executable by the core types 108, 110. Broadly speaking, the selection of physical and logical designs associated with mature functional specifications and/or significant service histories may mitigate the likelihood of undetected defects, while dissimilar means of implementing these functional specifications as discussed below may further reduce the likelihood that any such defects or faults are present throughout the IC device 100.

In embodiments, while the core types 108, 110 may be characterized as functionally identical and interchangeable with respect to their shared system design profiles 206 and functional design profiles 208, fabrication of the core types 108, 110 may introduce differentiation on multiple levels with respect to implementing the common functional profile 202. Broadly speaking, via fabrication of the core types 108, 110 according to dissimilar implementation profiles 204a, 204b, the redundancy of the core types may be preserved, e.g., the fulfillment of the macro-level common functional profile 202, while precluding any similar redundancy with respect to defects or common mode failures by introducing multiple levels or dimensions of differentiation with respect to the implementation of the common functional profile. Accordingly, any single defect or fault that might otherwise render redundant functions or systems unusable in one core type may not necessarily be reproduced in other redundant core types. Further, given that each core type 108, 110 may be associated with an instruction set having perhaps hundreds of functions, but may incorporate millions of logical elements and perhaps billions of transistors or other like components, implementation of the common functional profile 202 presents significantly more opportunities for the introduction of undetected faults or defects.

In embodiments, referring to FIGS. 2A and 2C, implementation profiles 204a, 204b may be differentiated from each other in terms of circuit design profiles 210a, 210b; circuit element design profiles 212a, 212b; and/or physical device parameters 214a, 214b. For example, a type I core 108, type II core 110, or other core type of the IC device 100 is ultimately a complex logical device comprising a set of interconnected integrated circuit elements or logical devices (e.g., logic gates). Similarly, each circuit element or logical device may comprise a set of interconnected circuit components, e.g., transistors, diodes, resistors, and/or other electronic components which serve as base-level building blocks for more complex circuit elements. For example, the implementation profile 204b may be implemented and may function similarly to the implementation profile 204a shown in detail by FIG. 2C in that the individual components and sub-components of the implementation profile, e.g., circuit design profiles 210b, circuit element design profiles 212b, physical device parameters 214b (and components thereof), may be defined dissimilarly to their counterpart components and sub-components of the implementation profile 204a although, as noted above, both implementation profiles 204a, 204b may be directed to the implementation and fabrication of functionally identical type I and type II processing cores 108, 110.

In embodiments, the selection of mature, tested functional profiles 202 having a significant service history may serve to mitigate the risk of undetectable errors. However, with respect to implementation profiles 204a, 204b for core types 108, 110 and other components of the IC device 100 sharing a common functional profile 202, design and process choices at each of these additional levels of decomposition (e.g., circuit design profiles 210a-210b, circuit element design profiles 212a-212b, physical device design profiles 214a-214b), may introduce additional opportunities for undetectable design errors (as noted above) but also provide additional means for differentiating functionally identical components and thereby further mitigating the risk of undetectable errors. Further, upper levels of decomposition, e.g., circuit design profiles 210a, 210b, may be informed by design and process decisions at lower levels, e.g., circuit element design profiles 212a, 212b with respect to the components of each circuit or logical device.

In embodiments, fabrication of the core types 108, 110 in fulfillment of the common functional profile 202 may introduce differentiation with respect to one or more aspects of the dissimilar implementation profiles 204a, 204b specific to the respective core types 108, 110. For example, implementation profiles 204a, 204b may include circuit design profiles 210a, 210b; circuit element design profiles 212a, 212b; and/or physical device design profiles 214a, 214b. Any or all of these aspects may provide an opportunity to add dimensions of dissimilarity between the core types 108, 110 such that any faults or defects found in one core type are less likely to be found in another.

These additional layers of dissimilarly or differentiation may further mitigate the likelihood of undetectable design errors within the IC device 100 (e.g., as opposed to the dissimilar application and monitoring cores disclosed in incorporated related application Ser. No. 18/639,523, which may differ with respect to their functional design profiles 208, e.g., with respect to their component instruction set architectures (ISA)).

In embodiments, and referring also to FIG. 2B, circuit design profiles 210a may be directed to logical devices 226 such as gates 226a (e.g., NAND, AND, NOR, XOR), flipflops 226b, data storage registers or elements 226c, and other circuits or logical devices of which the physical processors 216, graphics processors, memory and/or data storage 218, external interconnects 220, and other components specified by the common functional profile 202 are comprised. For example, each circuit design profile 210a may provide for a different configuration of one or more such logical devices 226 between the core types 108, 110. In embodiments, circuit design profiles 210a may include netlists 228 defining a physical circuit or logical device 226. For example, dissimilar netlists 228 between core types 108, 110 may define different physical implementations of the same circuit, as defined by logical design 222 components of the common functional profile 202 circuit. Alternatively, netlists 228 may define identical physical circuits or logical devices 226 with respect to the core types 108, 110, while the identical circuits or logical devices may be dissimilar at the circuit element design level 212a, 212b or with respect to their physical design parameters 214a, 214b.

In embodiments, circuit element design profiles 212a may provide for differentiation between the core types 108, 110 with respect to the configuration of transistors 230, diodes 232, resistors 234, and other circuit elements of which each logical device 226 or circuit, e.g., as addressed by the circuit design profiles 210a, is comprised. For example, even where circuit design profiles 210a provide for similar or equivalent logical devices 226 between the core types 108, 110 at the logical or circuit level, the dissimilar circuit element design profiles 212a may provide for different ways of implementing equivalent logical devices 226 at the component level.

In embodiments, physical design parameters 214a, may provide for dissimilarity between the core types 108, 110 at the lowest levels of implementation, with respect to physical design standards and/or processes via which the circuit elements (e.g., transistors 230, diodes 232, resistors 234) and/or logical devices are physically realized. For example, at the most basic level, the physical design of devices and components may be constrained by process geometries 236, fabrication standards 238, and/or other factors. In embodiments, fabrication standards 238 may include doping or masking processes 240 and/or other appropriate techniques for converting a logical design 222 or netlist 228 into a physical circuit or logical device 226. Further, fabrication standards 238 may include standards or processes 242 specific to individual fabricators, vendors, or suppliers, via which differentiation may be achieved by sourcing circuit elements (e.g., transistors 230, diodes 232, resistors 234) from different vendors across core types 108, 110. Further, even where general fabrication processes and toolsets are similar between fabricators, differences in logic synthesis and analysis for developing the schematic netlist 228 defining a physical circuit or logical device 226 and its component connections may persist. Different fabricators may employ different processes for converting the design intent of a given netlist 228 into a physical design and therefrom into masking/doping processes 240 and/or other means for implementing elements and components of the IC device 100 on a chip.

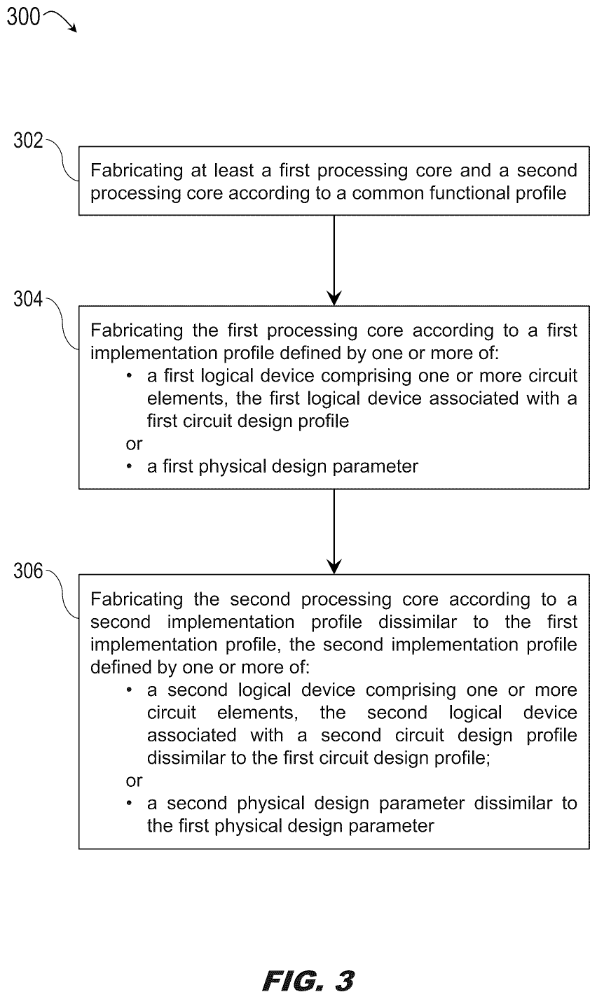

### FIG. 3—Method

In embodiments, a method 300 for fabrication of a heterogeneous IC device 100 incorporating differentiated core types 108, 110 is shown.

At a step 302, at least a first-type processing core and a second-type processing core are fabricated according to a common functional profile. For example, the common functional profile may functionally define the physical processors, data storage, and/or external interconnects equivalently across differentiated core types. In embodiments, the IC device may incorporate more than two differentiated core types and/or more than one processing core of each core type. In some embodiments, the common functional profile defines the logical designs of component circuits and/or logical devices shared by each core type (even though these circuits or devices may be implemented differently) and/or code languages executable across core types.

At a step 304, the first-type processing core/s are implemented according to a distinct implementation profile, e.g., for implementing as a physical processing core the common functional profile. For example, the first-type implementation profile may define at the logical level (e.g., via netlists) one or more logical devices or circuits comprising the first-type processing core according to the common functional profile. In some embodiments, the first-type implementation profile may additionally define design parameters for transistors, diodes, resistors, and/or individual circuit elements. In some embodiments, the first-type implementation profiles may include physical design parameters for implementation of circuits and/or circuit elements, e.g., process geometries and/or fabrication standards via which logical devices and/or elements thereof are physically implemented. For example, fabrication standards may include doping or masking processes and/or processes or procedures specific to a particular vendor, fabricator, or supplier.

At a step 306, the second-type processing core is fabricated according to a second-type implementation profile dissimilar to the first-type implementation profile in one or more ways. For example, the second-type implementation profile may implement similar netlists and/or circuit designs differently than the first-type implementation profile, e.g., via dissimilar circuits, dissimilar configurations of circuit elements comprising a particular circuit or logical device, and/or dissimilar physical device parameters via which logical devices, circuits, and/or circuit elements are physically implemented.

### CONCLUSION

Embodiments of the inventive concepts disclosed herein may further safeguard against the presentation of hazardously misleading information (HMI) or loss of function with respect to safety-critical avionics systems by adding additional dimensions of differentiation to a multicore processing environment, thus reducing the likelihood of undetected common mode and design faults across functionally identical processing cores.

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

We claim:

1. A method of fabricating a heterogeneous integrated circuit (IC) device, the method comprising:
fabricating at least a first processing core and a second processing core according to a common functional profile;
fabricating the first processing core according to a first implementation profile defined by one or more of:
a first logical device comprising one or more circuit elements, the first logical device associated with a first circuit design profile;
or
a first physical design parameter;
and
fabricating the second processing core according to a second implementation profile dissimilar to the first implementation profile, the second implementation profile defined by one or more of:
a second logical device comprising one or more circuit elements, the second logical device associated with a second circuit design profile dissimilar to the first circuit design profile;
or
a second physical design parameter dissimilar to the first physical design parameter.

2. The method according to claim 1, wherein the IC device is a system on a chip (SoC).

3. The method according to claim 1, wherein:
the at least one first logical device includes one or more of a first logic gate or a first data storage element associated with the first circuit design profile;
and
the at least one second logical device includes one or more of a second logic gate or a second data storage element associated with the second circuit design profile.

4. The method according to claim 1, wherein:
the first circuit design profile includes at least one first netlist;
and
the second circuit design profile includes at least one second netlist dissimilar to the at least one first netlist.

5. The method according to claim 1, wherein:
the at least one first physical design parameter includes one or more of a first process geometry or a first fabrication standard associated with the one or more circuit elements;
and
wherein the at least one second physical design parameter includes one or more of a second process geometry or a second fabrication standard associated with the one or more circuit elements.

6. The method according to claim 5, wherein:
the at least one first fabrication standard is associated with one or more of a first fabricator, a first supplier, or a first vendor;
and
wherein the second fabrication standard is associated with one or more of a second fabricator, a second supplier, or a second vendor.

7. The method according to claim 5, wherein:
the at least one first fabrication standard includes one or more of a first masking process or a first doping process;
and
wherein the second fabrication standard includes one or more of a second masking process or a second doping process.

8. The method according to claim 1, wherein the common functional profile is defined by one or more of:
a function executable on either of the first or second processing cores;
a physical processor of either of the first or second processing cores;
or
an external interconnect configured for connecting either of the first or second processing cores to one or more of a) the other of the first or second processing cores or b) a second IC device.

9. A heterogeneous integrated circuit (IC) device, comprising:
at least one of a first processing core and a second processing core fabricated according to a common functional profile,
wherein the at least one first processing core is fabricated according to a first implementation profile defined by one or more of:
a first logical device comprising one or more circuit elements;
or
a first physical design parameter;
and
wherein the at least one second processing core is fabricated according to a second implementation profile defined by one or more of:
a second logical device comprising one or more circuit elements;
or
a second physical design parameter.

10. The heterogeneous IC device of claim 9, wherein the heterogeneous IC device is a system on a chip (SoC).

11. The heterogeneous IC device of claim 9, wherein:
the at least one first logical device includes one or more of a first logic gate or a first data storage element associated with the first circuit design profile;
and
the at least one second logical device includes one or more of a second logic gate or a second data storage element associated with the second circuit design profile.

12. The heterogeneous IC device of claim 9, wherein:
the first circuit design profile includes at least one first netlist;
and
the second circuit design profile includes at least one second netlist dissimilar to the at least one first netlist.

13. The heterogeneous IC device of claim 9, wherein:
the at least one first physical design parameter includes one or more of a first process geometry or a first fabrication standard associated with the one or more circuit elements;
and
wherein the at least one second physical design parameter includes one or more of a second process geometry or a second fabrication standard associated with the one or more circuit elements.

14. The heterogeneous IC device of claim 13, wherein:
the at least one first fabrication standard is associated with one or more of a first fabricator, a first supplier, or a first vendor;
and
wherein the second fabrication standard is associated with one or more of a second fabricator, a second supplier, or a second vendor.

15. The heterogeneous IC device of claim 13, wherein:
the at least one first fabrication standard includes one or more of a first masking process or a first doping process;
and
wherein the second fabrication standard includes one or more of a second masking process or a second doping process.

16. The heterogeneous IC device of claim 13, wherein the common functional profile is defined by one or more of:
a function executable on either of the first or second processing cores;
a physical processor of either of the first or second processing cores;
or
an external interconnect configured for connecting either of the first or second processing cores to one or more of a) the other of the first or second processing cores or b) a second IC device.
